(19) United States
(12) Patent Application Publication
(10) Pub. No.: US 2007/0231632 A1
(43) Pub. Date: Oct. 4, 2007

(54) FUEL CELL SYSTEM

(76) Inventors: Ji-Cheng Zhao, Latham, NY (US); Ke Liu, Rancho Santa Margarita, CA (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/278,034

(22) Filed: Mar. 30, 2006

(51) Int. Cl. H01M 8/06; H01M 8/04

(52) U.S. Cl. 429/20; 429/26

(57) ABSTRACT

A fuel cell system comprises a hydrogen storage system for storing and releasing hydrogen, a fuel cell in fluid communication with the hydrogen storage system for receiving released hydrogen from the hydrogen storage system and for electrochemically reacting the hydrogen with an oxidant to produce electricity and an anode exhaust. A catalytic combustor is in fluid communication with the fuel cell for receiving the anode exhaust and for catalytically reacting the anode exhaust to produce an offgas having an elevated temperature that is greater than the temperature of the anode exhaust. The heat from the offgas is used to release the hydrogen from the hydrogen storage system.

### CROSS REFERENCE TO RELATED APPLICATIONS

This application is related to co-pending U.S. patent application Ser. No. 11/193,970, having docket number 183593-1 and entitled “Fuel Cell System,” U.S. patent application Ser. No. 11/292,583, having docket number 183593-2 and entitled “Fuel Cell System,” U.S. patent application Ser. No. 11/292,584, having docket number 183593-3 and entitled “Fuel Cell System,” each of which are herein incorporated by reference.

### BACKGROUND

This invention relates generally to fuel cell systems and more specifically to catalytically combusting an anode exhaust of a fuel cell, for example a Proton Exchange Membrane (PEM) fuel cell, to provide the heat to release hydrogen from a liquid storage material.

Fuel cells, for example PEM fuel cells, are touted as the future of the automotive industry. Fuel cells electrochemically react a fuel, such as hydrogen, with an oxidant, such as air, to produce electricity and water. PEM fuel cells are ideally suited for use in automobiles or for in-home applications and for many other applications.

In order for fuel cells to become practical for use within automobiles, a storage solution must be demonstrated that will provide the necessary quantities of hydrogen to the fuel cell. One of the fuel cell and storage combinations is a PEM fuel cell with a liquid storage medium. In this system, a hydrogen-charged liquid is pumped into a reactor that houses a catalyst. Alternatively, a homogenous catalyst is mixed with the liquid. The liquid and the catalyst are heated in the reactor such that at least part of the stored hydrogen within the liquid is released to the PEM fuel cell for electricity generation. Even with the assistance of a catalyst, a hydrogen-charged liquid must reach a certain temperature before it can release hydrogen. Typically, after hydrogen release, the hydrogen-depleted material is pumped back to a holding tank until it is adequately recharged with hydrogen either on-board or off-board. One concept for recharge involves pumping the hydrogen-depleted liquid out (at a refill station or the like) and pumping a new hydrogen-charged liquid into the system. In this concept, the hydrogen-depleted liquid can be regenerated as a hydrogen-charged liquid by reacting it with hydrogen in the presence of a catalyst off-board. This off-board concept has several advantages such as ease-of-use, safety, adaptability to existing gas station infrastructure, and it can be utilized without the use of a high-pressure tank or a cryogenic storage tank. These features are very attractive to on-board vehicular storage. Alternatively, the hydrogen-depleted liquid can be regenerated on-board a vehicle by re-charging with hydrogen in the presence of a catalyst. This concept is especially suited with a homogenous catalyst mixed into the liquid. It has the disadvantage of requiring heat removal during hydrogen charging, but has the advantage of re-charging on-board at a refill station without transporting the hydrogen depleted liquid into an off-site chemical plant.

Today's modern PEM fuel cells operate at relatively low temperatures, typically at about 80° C. Typically, the excess heat from the fuel cell is used to release the hydrogen from the hydrogen storage tank. Accordingly, it is widely assumed that the most practical applications would require the hydrogen storage tank to release hydrogen at about the same temperature that the fuel cell operates at, for example with PEM fuel cells, this temperature range would be from about 60° C. to about 80° C., and widely assumed to be less than 100° C. It is widely believed that the energy efficiency of the system will be lower, and the system will be more complex, if extra heat must be independently generated to release hydrogen from the tank.

One of the challenges for a PEM fuel cell system with a liquid carrier of hydrogen is that the PEM fuel cell exhaust temperature is too low to release hydrogen from most liquid carriers of hydrogen.

Another challenge of a PEM fuel cell system with a liquid carrier of hydrogen is the difficulty in starting the system under cold weather conditions. It is necessary for people in cold climates with temperatures as low as −20° C. to start the PEM fuel cell and hydrogen desorption. For the most part, no effective solution has been developed to solve the cold start problem.

Accordingly, there is a need to develop an improved fuel cell system that enables utilization of liquid carrier storage of hydrogen without requiring independent heat generation to release the hydrogen from the storage tanks. There is also a need to enable cold start of a PEM fuel cell and a hydrogen storage system.

### BRIEF DESCRIPTION

### Drawings

These and other features, aspects, and advantages of the present invention will become better understood when the following detailed description is read with reference to the accompanying drawings in which like characters represent like parts throughout the drawings, wherein:

FIG. 1 is a schematic illustration of a conventional fuel cell system using a liquid carrier of hydrogen.

FIG. 2 is a schematic illustration of one embodiment of the instant invention comprising a catalytic combustor in fluid communication with a fuel cell and a reactor to dehydrogenate hydrogen from a hydrogen-charged liquid carrier.

FIG. 3 is a schematic illustration of yet another embodiment of the instant invention comprising a catalytic combustor in fluid communication with a fuel cell and a reactor to dehydrogenate hydrogen from a hydrogen-charged liquid.

FIG. 4 is a schematic illustration of yet another embodiment of the instant invention comprising a catalytic combustor in fluid communication with a fuel cell and a reactor to dehydrogenate hydrogen from a hydrogen-charged liquid.

FIG. 5 is a schematic illustration of yet another embodiment of the instant invention comprising a catalytic combustor in fluid communication with a fuel cell and a reactor to dehydrogenate hydrogen from a hydrogen-charged liquid.

FIG. 6 is a schematic illustration of yet another embodiment of the instant invention comprising a catalytic combustor in fluid communication with a fuel cell and a reactor to dehydrogenate hydrogen from a hydrogen-charged liquid.

FIG. 7 is a schematic illustration of yet another embodiment of the instant invention to enable cold-start of the system.

FIG. 8 is a schematic illustration of yet another embodiment of the instant invention to enable on-board re-charging of the hydrogen-depleted liquid into the hydrogen-charged liquid.

### DETAILED DESCRIPTION

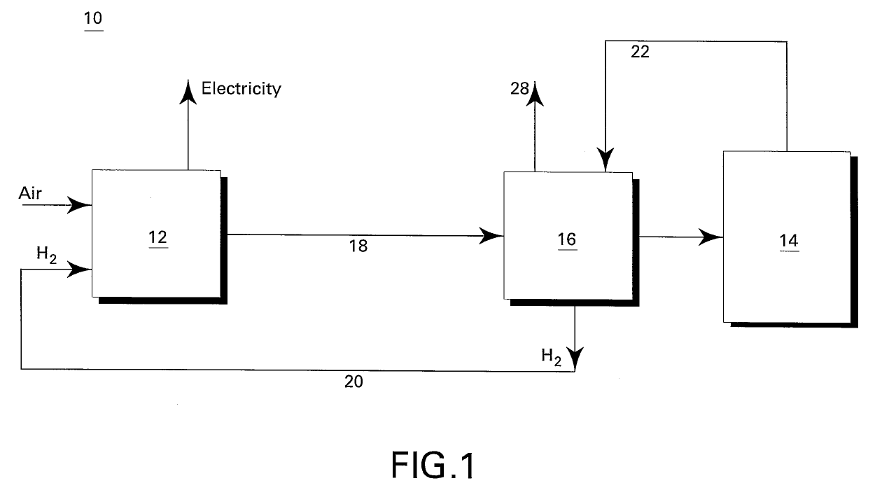

A fuel cell system 10 comprising a fuel cell 12, a liquid storage tank 14 and a catalyst reactor 16 is shown in FIG. 1. Typically, fuel cell 12 is a PEM fuel cell. As shown hydrogen (H₂) and air electrochemically react within fuel cell 12 to produce electricity and an exhaust 18. The exhaust 18 is typically used to heat the reactor 16 and the catalyst to a temperature suitable to dehydrogenate hydrogen 20 from a hydrogen-charged liquid 22 that is fed into the reactor 16 from the liquid storage tank 14. The exhaust 18 typically consists of water in the form of steam or moisture, nitrogen, and small quantities of hydrogen. After heating the reactor 16 and the catalyst, the remaining exhaust 28 vents outside of the system. Fuel cell system 10 is suited for many applications, especially for powering an automobile or other vehicles.

As discussed above, a significant challenge associated with implementing fuel cell system 10 into an automobile is the temperature required to dehydrogenate hydrogen 20 from the hydrogen-charged liquid 22. Accordingly, a significant amount of research is currently being conducted around identifying more effective catalysts to dehydrogenate hydrogen faster and at lower temperatures. Even with these research efforts, essentially all liquid media of hydrogen storage require temperatures higher than about 150° C. to effectively release hydrogen at an acceptable rate to feed into the fuel cells. This temperature of about 150° C. or higher is incompatible with the operating temperatures of the fuel cells. PEM fuel cells operate at about 80° C. There are two factors that limit PEM fuel cells from operating at higher temperatures: 1) the current PEM devices cannot withstand higher operating temperatures without system degradation; and 2) the PEM fuel cells need to be kept at a temperature below the boiling point of water to ensure the system is adequately hydrated. Accordingly, the current operating temperature limit of an ambient pressure PEM system is about 80° C. There are certain advantages to operate at higher temperatures, and for this reason, there are many efforts to develop higher temperature PEM systems. Future advancements of the PEM fuel cell might permit operating temperatures to push upwards to about 100° C. Even if the operating temperature of PEM fuel cells rises to 100° C., it is still not high enough to release most of the hydrogen stored in the hydrogen-charged liquid 22.

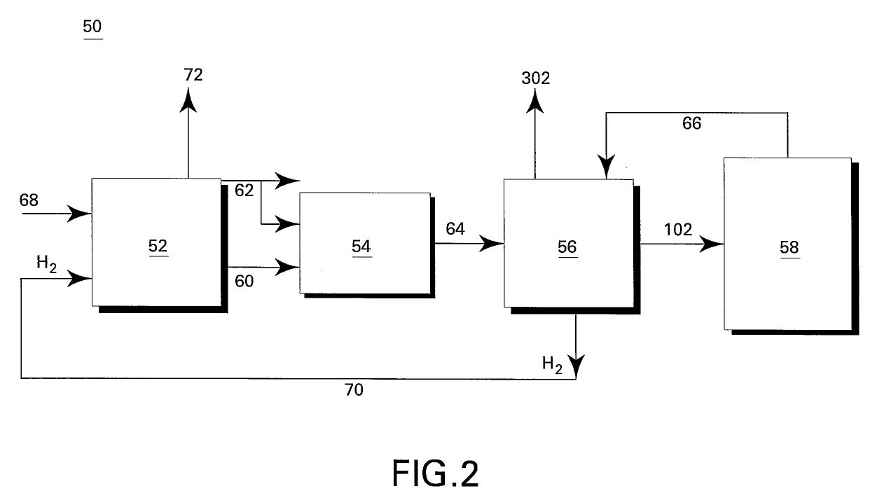

In accordance with one embodiment of the instant invention, a fuel cell system 50 is shown in FIG. 2. Fuel cell system 50 comprises a fuel cell 52, a catalytic combustor 54, a reactor 56 with a catalyst, and a liquid storage tank 58. As will be discussed in greater detail below, fuel cell system 50 significantly advances the art of fuel cell systems using liquid media for hydrogen storage, especially for organic liquid carriers of hydrogen.

The anode exhaust 60 from the fuel cell 52 is mixed with a fraction of the cathode exhaust 62 and combusted in catalytic combustor 54 to produce an offgas 64 with a temperature greater than about 150° C., and typically greater than 200° C. The higher temperature offgas 64 is used to raise the temperature of the hydrogen-charged liquid 66 and the catalyst in reactor 56 to release the hydrogen from the liquid 66. The higher temperature offgas 64 enables a variety of hydrogen-charged liquids 66, some existing, some yet to be developed, to be used effectively with PEM fuel cells.

Fuel cell 52, is typically a PEM fuel cell but can include a variety of other fuel cell types including but not limited to a phosphoric acid fuel cell, a solid oxide fuel cell or an alkali fuel cell. PEM fuel cells are typically associated with onboard or automotive applications, so many discussions within this application will focus on PEM fuel cells. While certain embodiments of this invention may primarily be discussed with reference to PEM fuel cells, this is not a limitation of this invention. An oxidant 68, typically air, and hydrogen (H₂) 70, are introduced into fuel cell 52 and electrochemically react to produce electricity 72, cathode exhaust 62 and anode exhaust 60 comprising water (H₂O) and small quantities of unutilized H₂, for example less than about 15% by volume of the anode exhaust 60, and typically less than about 10% by volume. Typical H₂ utilization efficiency in a PEM fuel cell is less than about 90%, so there is always some percentage of H₂ that cannot be converted inside the PEM fuel cell that is released via the anode exhaust 60. Anode exhaust 60 is typically so dilute in H₂, and contains such large quantities of steam, that homogeneous combustion cannot efficiently be utilized to recover heat from the anode exhaust 60 to take advantage of this otherwise wasted energy. Instead, the anode exhaust 60 is typically used directly, at its existing temperature, around 80° C., to heat the hydrogen storage system to release the hydrogen.

In the instant invention, however, anode exhaust 60 is directed into catalytic combustor 54. The anode exhaust 60 is catalytically reacted to produce an offgas 64 having an elevated temperature, for example greater than about 150° C. and typically greater than 200° C. In some embodiments of the invention, the temperature of the offgas 64 is between about 200° C. to about 900° C. In other embodiments of the invention, the temperature of the offgas 64 is between about 200° C. to about 500° C.

In catalytic combustor 54, part of the cathode exhaust 60 is mixed with the anode exhaust 62 at a predetermined ratio and is fed to a combustion catalyst such as Pt/Al₂O₃, Pt—Pd/Al₂O₃, Pt—Rh/Al₂O₃, Pt—Ru/Al₂O₃, or Pt—Ir/Al₂O₃. Once the constituents begin to catalytically react, the small amount of H₂ in the anode exhaust 60 will react with the O₂ in the cathode exhaust 62 to generate heat. Depending on the H₂ concentration of the anode exhaust 60, and the ratio of O₂ to H₂ or cathode exhaust to anode exhaust feeding into the catalytic combustor 54, the temperature of the catalyst (typically a catalyst bed), and correspondingly the temperature of the offgas 64, can be controlled over a wide temperature range, for example from about 150° C. to about 900° C.

A partial list of the liquid carrier materials for storing hydrogen in tank 58 is shown in TABLE 1. The term hydrogen-charged liquid includes only partially charged liquid. Similarly, the hydrogen-depleted liquid also includes the hydrogen partially depleted liquid.

TABLE 1

| Hydrogen-charged Liquid | Hydrogen-depleted Liquid |
|---|---|
| Decalin | Naphthalene |
| Tetralin | Naphthanlene |
| Methylcyclohexane | Toluene |
| Perhydro-N-ethylcarbazole | N-ethylcarbazole |
| Cyclohexane | Benzene |
| Dicyclohexyl | Biphenyl |

For instance, decalin can be dehydrogenated to form naphthalene and releases about 7.3-weight percent hydrogen. With a catalyst of about 5% platinum and rhenium on a carbon support, the conversion rate from decalin to naphthalene at 210° C., 240° C., and 280° C. is about 50%, 80% and 100% respectively. The hydrogenation speed is also much faster at higher temperatures. For instance, at 210° C. for 2.5 hours, only about 50% decalin converts to naphthalene; whereas at 280° C. only about 0.5 hour is needed to reach the same conversion amount. The higher the temperature, the faster and the more complete the dehydrogenation process. In addition, only at temperatures higher than 210° C., does the dehydrogenation rate become reasonable to provide hydrogen to fuel cells. This temperature is incompatible with the existing fuel cell system, but it can readily provided by the instant invention.

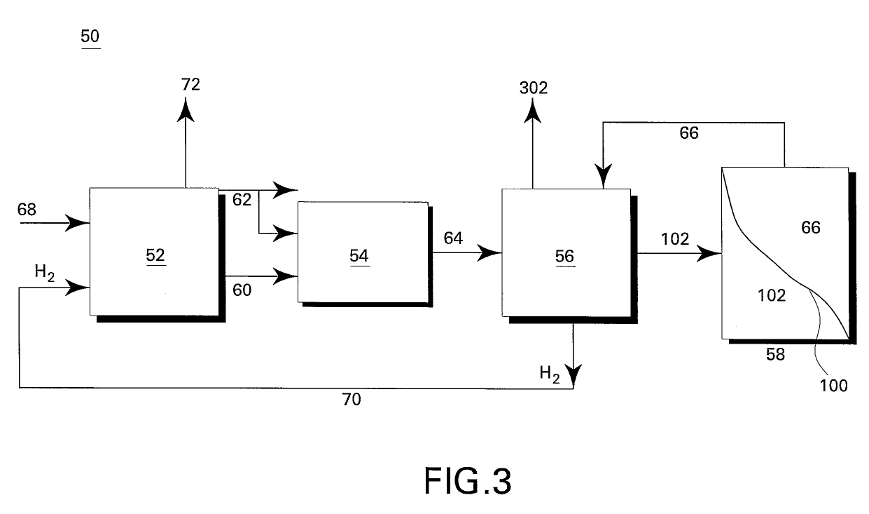

Another embodiment of the instant invention is shown in FIG. 3. The fuel cell system 50 further comprises a flexible diaphragm 100 that separates the hydrogen-charged liquid 66 from hydrogen-depleted liquid 102. In some cases, there may be enough density difference between the hydrogen-charged liquid 66 and the hydrogen-depleted liquid 102 to enable both to be stored in the same tank while still being able to be separated from each other for pumping. For most cases, the density difference is likely too small such that separate storage spaces are required for the hydrogen-charged liquid 66 and the hydrogen-depleted liquid 102. The diaphragm 100 avoids the need of separate tanks for the hydrogen-charged liquid 66 and hydrogen-depleted liquid 102 respectively, thus saving the space required to store them. The space of storing hydrogen is a very important factor in selecting various hydrogen storage solutions for on-board vehicular applications such as automobiles. In some embodiments, the flexible diaphragm 100 is made of various high-temperature rubbers or other plastic materials. The key properties of the diaphragm materials are: 1) the ability to sustain a high temperature such as about 250° C. to about 400° C.; 2) being relatively inert to both the hydrogen-charged liquid 66 and the hydrogen depleted liquid 102; and 3) resistance to significant degradation in a predetermined life period, such as 10 years. In one preferred embodiment of the instant invention, the diaphragm 100 is made up of red iron oxide filled silicone rubber. The material can sustain up to 400° C. and is flexible and rubber-like.

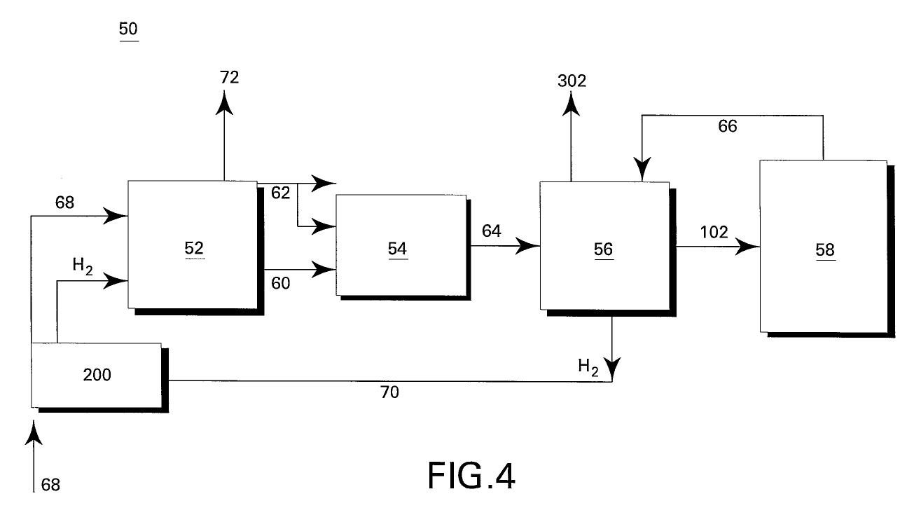

In yet another embodiment of the instant invention shown in FIG. 4, the fuel cell system 50 comprises at least one heat exchanger 200. When the dehydrogenation is performed in reactor 56 at a temperature higher than 150° C., the released hydrogen 70 will be at approximately the same temperature at which the reactor 56 operates. The temperature of the hydrogen 70 may be higher than the operating temperature of the fuel cell 52. Especially when the fuel cell 52 is a PEM fuel cell, then the hydrogen feeding into the fuel cell 52 should be less than about 100° C., and preferably less than about 80° C. In this case, a heat exchanger 200 is added into fuel cell system 50. The heat exchanger 200 reduces the temperature of the hydrogen 70 to a temperature suitable for use within fuel cell 52 and at the same time uses the energy to heat the feeding air 68 from ambient temperature to a temperature suitable for feeding into the fuel cell 52, improving the overall system efficiency.

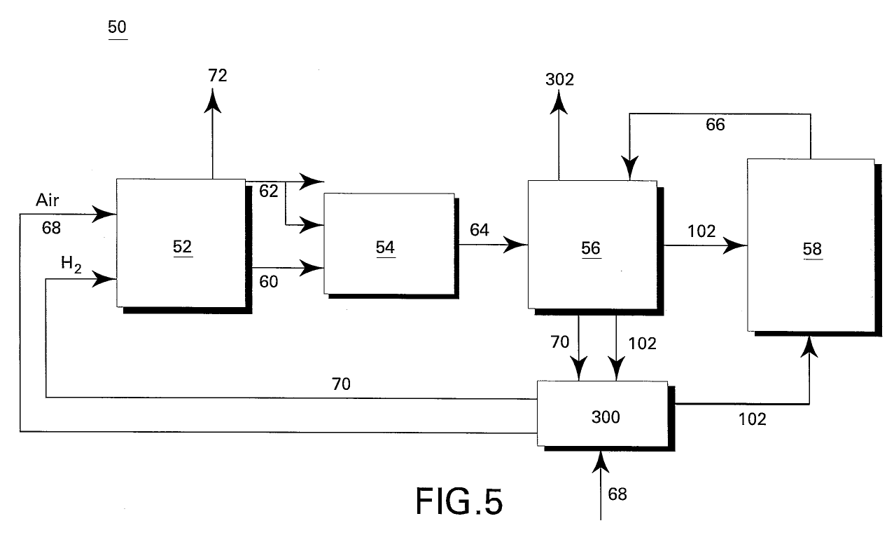

In yet another embodiment of the instant invention shown in FIG. 5, the fuel cell system 50 comprises a heat exchanger 300 to recover the excess heat (energy) from the hydrogen-depleted liquid 102, the hydrogen 70 and the exhaust vent 302 coming out of the reactor 56 to optionally raise the temperature of the feeding air 68 or other oxidant into the fuel cell 52.

In yet another embodiment of the instant invention, the fuel cell system 50 comprises a plurality of heat exchangers to optimize the thermal management of the entire system. The heat exchangers take advantage of the excess heat from the hydrogen-depleted liquid 102, the hydrogen 70, and the exhaust vent 302 to: 1) raise the temperature of the feeding air or other oxidant into the fuel cell 52, 2) heat the anode exhaust 60 and the cathode exhaust 62 feeding to the catalytic combustor 54, 3) heat other parts of a larger system outside the fuel cell system 50 such as a vehicle that uses the fuel cell system 50, or 4) generate electricity using a thermoelectric material.

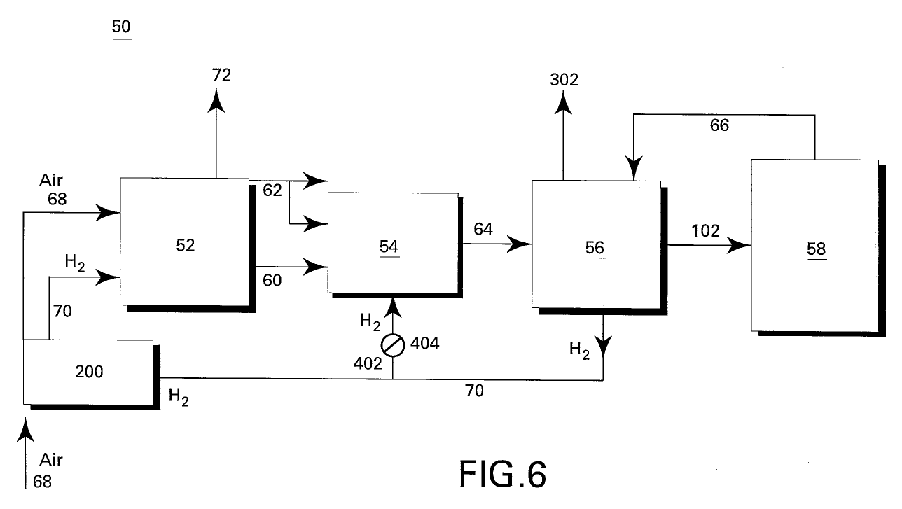

Depending on the heat of desorption (ΔH) of the hydrogen-charged liquid 66 and the available residual hydrogen in the anode exhaust 60, one embodiment of the instant invention is shown in FIG. 6 and involves the use of a small fraction 402 of the desorbed hydrogen 70 to feed into the catalytic combustor 54. A valve 404 may optionally stay open and be adjusted to provide additional hydrogen for the desorption of the hydrogen from the hydrogen-charged liquid 66. For instance, when 8% of residual hydrogen is available in the anode exhaust 60, catalytic combustion of it can produce about 19 kJ/mole of heat. If the heat of desorption (ΔH) of the hydrogen-charged liquid 66 is 35 kJ/mole of H₂, then about 7% of the hydrogen needs to be bled through valve 404 to completely release all hydrogen from the hydrogen-charged liquid 66.

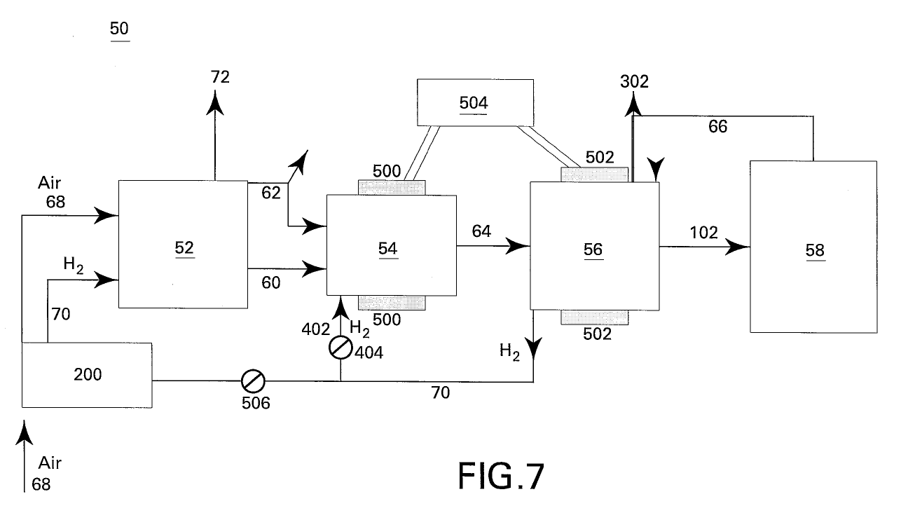

One embodiment of the instant invention is to enable easy cold start of the fuel cell and the dehydrogenation reaction in the reactor 56. This embodiment is schematically shown in FIG. 7. To enable cold start, at least one electrical heater 500 is integrated with the catalytic combustor 54 and at least one electrical heater 502 is integrated with the reactor 56. Ultrafast electric heaters with capability of heating to 300° C. in a few seconds are known in the art. An exemplary metal foil catalyst support heater was developed for an automotive catalyst support to solve the cold-start emission problem. The heat conductivity of such metal supports is good, and the support material is robust to sustain the expansion due to the fast heat-up of such a catalyst support. By wash-coating the catalytic combustion catalyst onto the surface of the electrically heated metal foil heater elements, it is possible to heat the catalyst bed from 80° C. to 300° C. in a few seconds. Similarly, the dehydrogenation catalyst in the reactor 56 can also be wash-coated onto the surface of the electrical heater 502 to heat the catalyst from ambient temperature to a temperature such as 300° C. suitable for dehydrogenation of the hydrogen-charged liquid 66. A battery 504 provides the electrical current to both electrical heaters 500 and 502 for the first few seconds. With valve 404 closed and valve 506 open at the beginning, the hydrogen 70 released from the reactor 56 is fed into fuel cell 52 to start it. The exhausts 60, 62 are fed into the catalytic combustor 56 to start the catalytic combustion reaction to generate heat. The heat is used to further dehydrogenate the hydrogen-charged liquid to release hydrogen to feed the fuel cell 52. In an alternative embodiment of the invention, valve 404 is open and valve 506 is closed at the beginning, the hydrogen 70 released from the reactor 56 is fed into the catalytic combustor 54 to start the catalytic combustion reaction to generate heat. The heat is used to further dehydrogenate the hydrogen-charged liquid 66 to release hydrogen to feed the fuel cell 52 by opening valve 506. After the fuel cell 52 starts, the electrical heaters 500, 502 can be shut off and valve 404 can also be shut off or adjusted to the appropriate hydrogen bleeding level to ensure maximum desorption of the hydrogen 70 from the hydrogen-charged liquid 66.

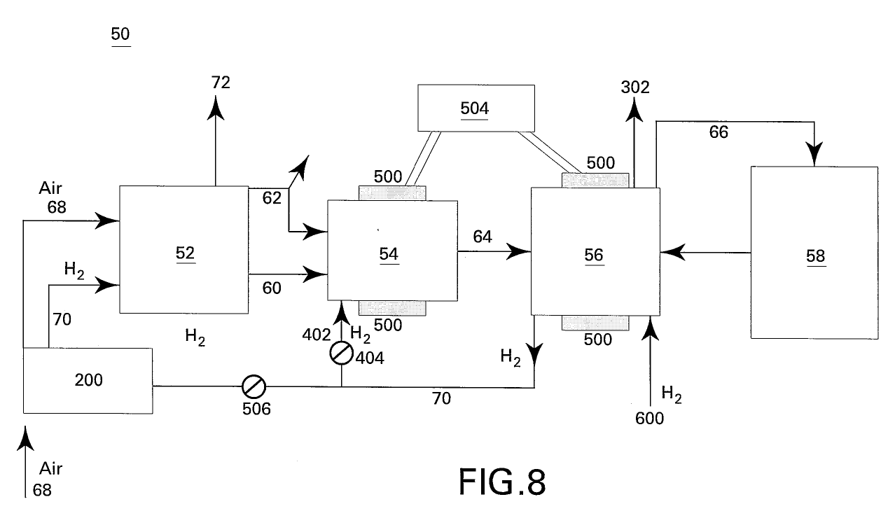

When it is time for re-filling at a gas station, the hydrogen-depleted liquid 102 is pumped out and new hydrogen-charged liquid 66 is refilled. The hydrogen-depleted liquid 102 is regenerated to hydrogen-charged liquid 66 by reacting it with hydrogen at the presence of a catalyst. The re-hydrogenation is typically performed off-board of a vehicle at a gas station or at a place away from the gas station in a central chemical plant. The advantage of such a process is easy re-fueling, easy adoption to existing gas station infrastructure, and minimum re-fueling time. Alternatively, the hydrogen-depleted liquid 102 may be regenerated on-board a vehicle by re-charging with hydrogen in the presence of a catalyst. This embodiment of the instant invention is schematically shown in FIG. 8. At the time of re-fuelling, if the fuel cell 52 is off and the reactor 56 is cold, a hydrogen source 600, preferably in the form of compressed hydrogen gas, is brought into fluid contact with the reactor 56. The hydrogen can first bypass the reactor 56 and flow to the catalytic combustor 54 (when valve 404 is open and valve 506 is closed). By using battery 504 to provide electrical current to the electrical heaters 500, 502 for a few seconds to heat up the catalyst for the catalytic combustor 54 and the catalyst for the reactor 56, the catalytic combustion and re-hydrogenation can take place. The heat generated during the re-hydrogenation process is used to provide the heat to keep the reactor at the temperature required for re-hydrogenation. In this case, the catalytic combustor 54 can be shut off. If too much heat is generated during the re-hydrogenation reaction, then a cooling medium may be introduced to cool down the reactor to the appropriate temperature. The cooling medium has no fluid communication with the catalyst or with the hydrogen-charged liquid and the hydrogen-depleted liquid, but it has heat transfer/conduction relationship with them. If the heat generated during the re-hydrogenation process is insufficient to sustain the temperature of the reactor 56, then a small fraction of the hydrogen can be introduced to catalytic combustor 54 by adjusting valve 404. The heat of catalytic combustion will keep the reactor 56 at a desired temperature.

When the fuel cell 52 is running during re-fueling, the high temperature exhaust 64 from the catalytic combustor should preferably be ducted temporarily away from the reactor 56 if the heat of re-hydrogenation is very high. A coolant can be optionally introduced to remove excess heat from the reactor 56. If the re-hydrogenation heat is low, a fraction of the catalytic combustor exhaust 64 can be introduced to maintain the reactor 56 at a desired temperature. Thermal management, balance, and control should be apparent to those skilled in the art.

In the case that a homogenous catalyst is mixed with the hydrogen-charged liquid and the hydrogen-depleted liquid, the hydrogen may be directly introduced into the storage tank 58 to convert the at least partially hydrogen-depleted liquid into the at least partially hydrogen-charged liquid. If the excess heat is high, cooling mechanisms may be introduced into the storage tank 58 to remove part of the heat in order to maintain the storage tank 58 at a desired hydrogenation temperature.

Again in the case that a homogenous catalyst is mixed with the hydrogen-charged liquid and the hydrogen-depleted liquid, it may be possible to combine the reactor 56 with the storage tank 58. Heat exchanger mechanisms are introduced into the tank to heat the liquids and the catalyst to the desired temperature for hydrogenation and dehydrogenation.

Depending on the properties of the hydrogen-charged liquids 66, some of them may have a high vapor pressure such that the gas (predominately hydrogen) coming out of the reactor 56 may have small amounts of evaporated gas of the hydrogen-charged liquid materials in addition to desorbed hydrogen. In this case, a condenser may be introduced to remove the evaporated materials thus producing high purity hydrogen to the fuel cell. In other cases, the dehydrogenation process produced multiple gases. In this situation, hydrogen membranes known in the art can be used to filter high-purity hydrogen to feed into the fuel cell. A known hydrogen membrane material is pure Palladium (Pd).

While only certain features of the invention have been illustrated and described herein, many modifications and changes will occur to those skilled in the art. It is, therefore, to be understood that the appended claims are intended to cover all such modifications and changes as fall within the true spirit of the invention.

1. A fuel cell system comprising:
a storage system for storing and releasing a liquid carrier comprising hydrogen;
a reactor for receiving said liquid carrier to catalytically dehydrogenate said liquid carrier to produce a hydrogen flow;
a fuel cell in fluid communication with said reactor for receiving said hydrogen flow from said reactor and for electrochemically reacting said hydrogen flow with an oxidant to produce electricity and an anode exhaust; and
a catalytic combustor in fluid communication with said fuel cell for receiving at least a portion of said anode exhaust and for catalytically reacting said anode exhaust to produce an offgas having an elevated temperature that is greater than the temperature of said anode exhaust;
wherein heat from said offgas is used to heat said reactor to catalytically dehydrogenate said liquid carrier to produce said hydrogen.

2. A fuel cell system in accordance with claim 1, wherein said fuel cell is a PEM fuel cell.

3. A fuel cell system in accordance with claim 1, wherein said anode exhaust comprises less than about 15% by volume of hydrogen.

4. A fuel cell system in accordance with claim 1, wherein the temperature of said anode exhaust is in the range between about 60° C. to about 150° C.

5. A fuel cell system in accordance with claim 1, wherein the temperature of said anode exhaust is less than 150° C.

6. A fuel cell system in accordance with claim 1, wherein the temperature of said offgas is greater than about 150° C.

7. A fuel cell system in accordance with claim 1, wherein the temperature of said offgas is in the range between about 150° C. to about 900° C.

8. A fuel cell system in accordance with claim 1, wherein said catalytic combustor comprises a combustion catalyst.

9. A fuel cell system in accordance with claim 8, wherein said combustion catalyst is at least one of Pt/Al₂O₃, Pt—Pd/Al₂O₃, Pt—Rh/Al₂O₃, Pt—Re/Al₂O₃, Pt—Ru/Al₂O₃, or Pt—Ir/Al₂O₃.

10. A fuel cell system in accordance with claim 1, wherein said liquid carrier is selected from the group consisting of Decalin, Tetralin, Methylcyclohexane, Perhydro-N-ethylcarbazole, Cyclohexane, and Dicyclohexyl.

11. A fuel cell system in accordance with claim 1, wherein said storage system includes a tank having a flexible diaphragm that separates said liquid carrier comprising hydrogen from hydrogen-depleted liquid carrier.

12. A fuel cell system in accordance with claim 11, wherein said diaphragm is made of a high temperature rubber or plastic.

13. A fuel cell system in accordance with claim 11, wherein said diaphragm is made of red iron oxide filled silicone rubber.
